(19) United States
(12) Patent Application Publication
(10) Pub. No.: US 2018/0365693 A1
(43) Pub. Date: Dec. 20, 2018

(54) Remote Fee Collection Apparatus and Method

(71) Applicant: Sani-Star, LLC, Sisters, OR (US)

(72) Inventor: Eric Huffman, Sisters, OR (US)

(73) Assignee: Sani-Star, LLC, Sisters, OR (US)

(21) Appl. No.: 16/002,164

(22) Filed: Jun. 7, 2018

Related U.S. Application Data
(60) Provisional application No. 62/521,389, filed on Jun. 17, 2017.

(51) Int. Cl. G06Q 20/40; G06Q 20/34; G06Q 20/18; G06Q 20/20

(52) U.S. Cl. CPC G06Q 20/401; G06Q 20/34; G06Q 2240/00; G06Q 20/209; G06Q 20/18

(57) ABSTRACT

A fee collection apparatus and methods defines a secure manner of collecting fees with electronic payments where there is no form of communication from the location of the fee collection apparatus such as telephone lines, W-Fi, or cellular networks, and where typically there is no source of grid power supply. Data from users is collected and stored in a remotely located kiosk, then securely transferred to a remote device operated by an operator such as a campground employee. The remote device is then transported to a location where telecommunications services are available (such as W-Fi, cellular networks) and is securely transmitted to a processing system (cloud or otherwise). Payment card data are transmitted to a financial transaction processor pursuant to Payment Card Industry Data Security Standards (PCI DSS).

### TECHNICAL FIELD

The present invention relates to apparatus and methods used to collect fees, and more particularly, to devices that are used to collect fees in remote areas where regular power and telecommunications signals (such as cellular, WiFi, internet, etc.) are usually not available and where an attendant or cashier is either not available or available only at intermittent times.

### BACKGROUND

A variety of different user fees are assessed in many different settings. To cite just a few examples, many national and state parks charge fees for day and overnight use of camp sites in the parks. Similarly, both state and federal agencies charge user fees for purchasing parking passes at trail heads, and for trail passes. Often, users are able to purchase permits and other types of passes either online before they arrive at the location where the pass is required, or in-person at a local office facility. But just as often, the campgrounds and trail heads and the like are set up with an on-site fee collection system. These on-site fee collection stations are very convenient for users who arrive at a fee-charging location without a pre-purchased permit.

Fee collection sites are often located in remote areas and are just as often unattended by cashiers or others to collect the fees. For example, many campgrounds are either wholly unattended, or are attended only sporadically. And trailheads are almost never attended. As such, the conventional solution to fee collection is to install a so-called “iron ranger,” which is essentially a strong box that is provided for users to deposit a cash payment. There is usually a supply of paper fee receipts and pencils and envelopes; the user fills out requested information on the fee receipt and deposits the necessary amount of cash into the strong box. One copy of the fee receipt is deposited in the strong box and one copy is kept by the user as proof of payment; it is typically displayed on a vehicle's windshield or at a camp site.

This conventional fee collection system tends to be very labor intensive and is prone to innumerable problems. From the labor perspective, a representative from the fee-charging agency must collect the cash from a strong box, and then compare the amount of cash with the fee receipts to insure that each user has paid the proper amount. The employee may also need to verify that the user has not, for instance, over stayed at the site compared to the amount of the payment. This is repeated at numerous fee-collection sites. The cash eventually is turned in to the collecting agency where receipts are matched up with payments by another employee. In addition to taking a significant amount of time, many employers do not want their employees carrying cash around because they could be obvious targets for theft. It is also very difficult to make an accurate accounting of the fees that have been charged and as such, the opportunities for theft of cash by the employee are increased. In addition, the campground or parking lot management organization (such as the US Forest Services, State Park Services, National Parks Services, or concessionaires for these organizations—collectively referred to herein at places as “concessionaires”) are required to provide reports that summarize data such as occupancy, revenues, etc.

Moreover, a cash based fee system requires the user such as a camper, parking customer, etc. to (a) have cash on hand, and (b) have the correct amount of cash (since there is no opportunity for change to be made). This is a significant inconvenience for many users, especially in today's economy where cash transactions are becoming far less common.

Traditional fee strong boxes are also favorite targets of vandals and thieves. Any agency that collects user fees through a strong box understands that no matter how strong and secure a remotely located strong box might be, where the box contains cash it will be a prime target for being broken into and the cash stolen. This kind of thievery is nearly impossible to prevent.

The strong box payment systems also open the system up to opportunism by dishonest users and dishonest employees. For example, a user may deposit enough cash to pay for one night's camping, and fill out the fee receipt improperly while using the camp site for many days. In an unattended camp ground, this kind of dishonesty is very difficult to detect. And theft by dishonest employees is equally a risk where paper-based transactions and cash payments do not leave a data trail for accountants to follow.

There are some automated fee collection systems on the market that attempt to address the well-known problems that arise from strong box systems. However, the automated systems are themselves subject to many limitations, including security and the requirement for hard-wired power and often, data signals.

For the reasons articulated above there is a need therefore for apparatus that allow for automated collection of fees at remote locations where grid power systems and data signals are not available, and which provide for secure transactions of electronic payments. Further, credit card transactions must be PCI compliant (Payment Card Industry) in terms of data security and in a no-data environment this security requirement presents special problems that must be solved.

The present invention comprises a fee collection apparatus and methods that address the shortcomings of prior systems. More specifically, the present invention provides for a secure manner of collecting fees with electronic payments where there is no form of communication from the location of the fee collection apparatus such as telephone lines, Wi-Fi, or cellular networks (collectively referred to herein as “telecommunications services”), and where typically there is no source of grid power supply. The invention further provides a simple manner for concessionaires and the like to generate reports.

### BRIEF DESCRIPTION OF THE DRAWINGS

The invention will be better understood and its numerous objects and advantages will be apparent by reference to the following detailed description of the invention when taken in conjunction with the following drawings, in which:

FIG. 1 is a perspective view of a complete kiosk that defines a fee collection apparatus and method according to an exemplary and illustrated embodiment of the present invention.

FIG. 2 is a front perspective view of the main enclosure of the kiosk shown in FIG. 1.

FIG. 3 is a side elevation and cross sectional view of the main enclosure of the kiosk shown in FIG. 1 and taken along the line 3-3 of FIG. 2.

FIG. 4 is a schematic perspective representation of a fee collection apparatus and method according to a second exemplary and illustrated embodiment of the present invention.

FIG. 5 is a schematic perspective representation of a data transfer device according to the present invention.

FIG. 6 is a schematic perspective representation of a computer base station for use with the present invention.

FIGS. 7 through 10 are a series of schematic illustrations that comprise an exemplary series of step-by-step instructions as they could be displayed on a screen display associated with the kiosk of FIG. 1, illustrating sequentially some steps that a user may encounter upon using the fee collection apparatus according to the invention. Specifically,

FIG. 7 is a schematic representation of an exemplary introduction screen;

FIG. 8 is a schematic representation of an exemplary screen on which the user is requested to enter a camping site number;

FIG. 9 is a schematic representation of an exemplary screen on which the user is requested to enter user identifying information;

FIG. 10 is a schematic representation of an exemplary screen on which the user is requested to enter the number of people who would be staying at the selected camp site.

FIG. 11 is a flow chart that continues the sequential step-by-step instructions from FIG. 10, but in which the screen display is omitted.

FIG. 12 is a flow chart that illustrates the basic flow of data according to the present invention.

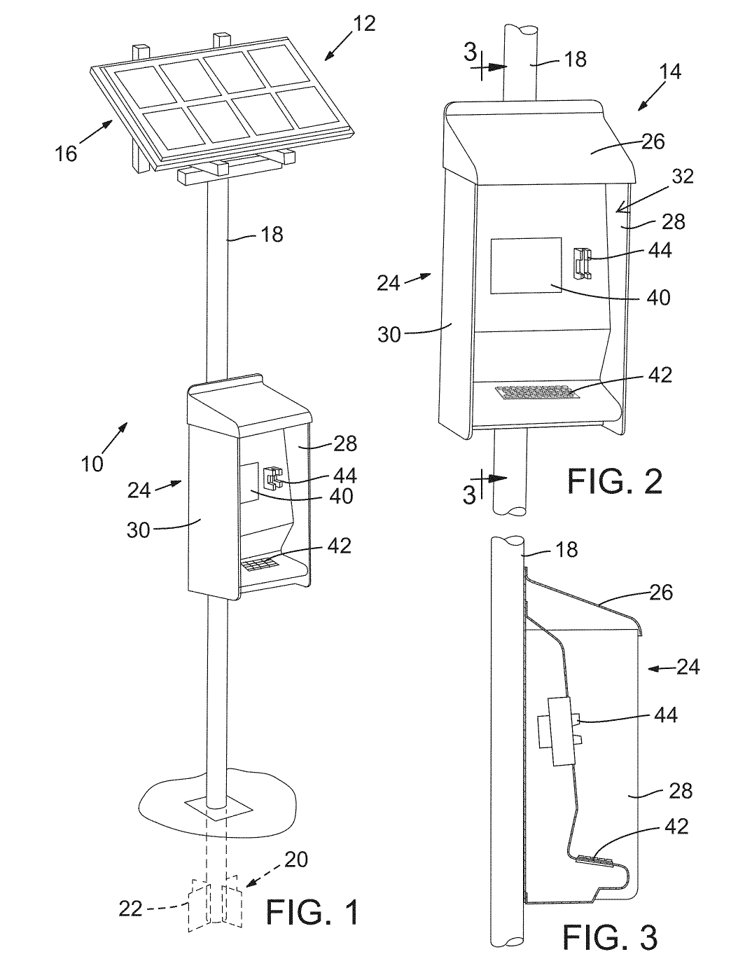

### DETAILED DESCRIPTION OF ILLUSTRATED EMBODIMENTS

The invention will now be described in detail with reference to the drawings. FIG. 1 shows a fee collection apparatus 10 embodied in a complete kiosk 12. The kiosk 12 is adapted to be located in remote locations that have no external power supply available (i.e., no grid power supply) and no telecommunications services such as Wi-Fi or cell signals. The kiosk 12 is defined by a main enclosure 14 that as detailed below contains the working components of the fee collection apparatus 10, and a solar panel 16; the main enclosure 14 and the solar panel 16 are preferably mounted on a post 18. The post 18 has a base 20 that is configured for insertion into the ground to securely support the main enclosure and the solar panel. The base 18 may include support fins 22 that help retain the post 18 in position—the post may be secured in place with concrete and the like.

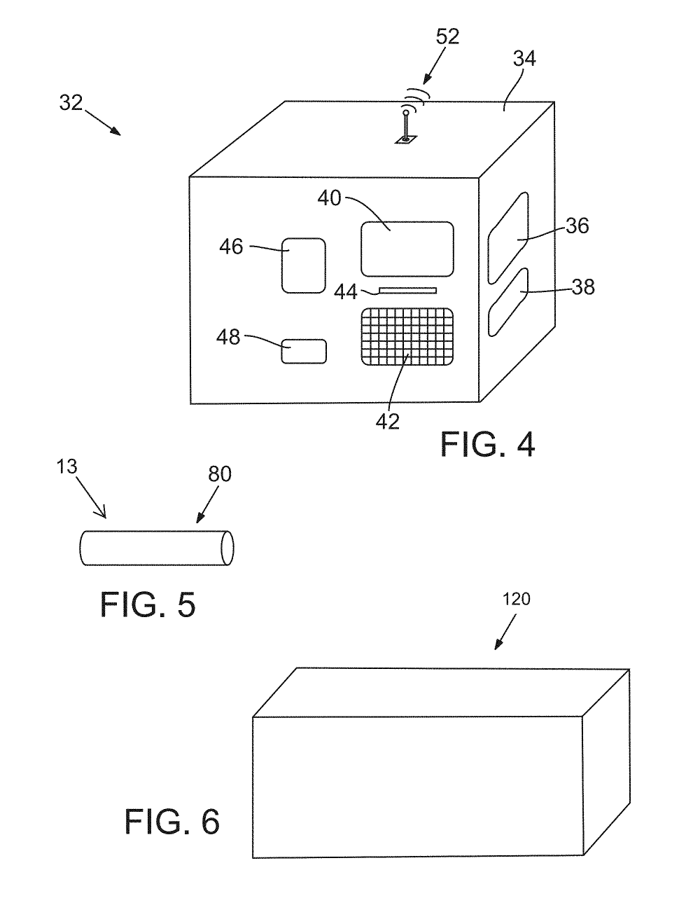

Main enclosure 14 houses the primary working components of the fee collection apparatus 10 and includes a housing 24 defined by a top cover 26 and opposed side panels 28 and 30. The housing 24 provides one layer of protection from the weather for the user interface module 32, which is located within the housing 24. As detailed below, the user interface module 32 is a water and weatherproof box that contains a computer, an internal power supply, and user interface components including a keyboard, display screen and a card reader. The user interface module 32 is shown schematically in FIG. 4 and reference is now made to that figure. Module 32 is a secure and waterproof enclosure 34 that houses a computer 36, which is a conventional computer that is programmed with software that facilitates operation of fee collection apparatus 10 as described herein. Computer 36 includes data storage capability and the ability to encrypt data and to export the encrypted data. Fee collection apparatus 10 has a stand-alone power supply so that the apparatus may be installed in remote locations where there is no grid power, or where otherwise a hard-wired power connection is not possible. As such, the internal power supply 38 is preferably a battery, preferably a rechargeable battery system. The enclosure 34 is designed so that the power supply 38 may be secured within the enclosure, but is accessible to change out a depleted battery with a fully charged battery. Since the apparatus 10 will often be installed in remote locations where grid power is not available, the solar panel 16 is provided to charge the power supply 38. Solar panel 16 is sized appropriately for the power uses in any particular installation—for example, a 100 watt, 12 v DC solar panel is exemplary.

A display 40 is located adjacent a user input device 42 such as a waterproof keypad or touch pad. The display 40 may be a touch screen, in which case the display screen defines the user input device 42. The display 40 is, as with all components of fee collection apparatus 10, designed to be waterproof. A card reader 44 is located in a convenient location on enclosure 34 and is capable of reading conventional electronic payment cards including credit cards and debit cards, whether of the type using magnetic strips, data chips or other data systems for use on payment cards.

Fee collection apparatus 10 may preferably include a printer 46 that feeds fee receipts to the user through a printer output slot 48. The printer 46 may be seen as optional and in an alternative embodiment the user may download a receipt to a smart phone or similar device, or may take a photograph of a receipt displayed on the display screen.

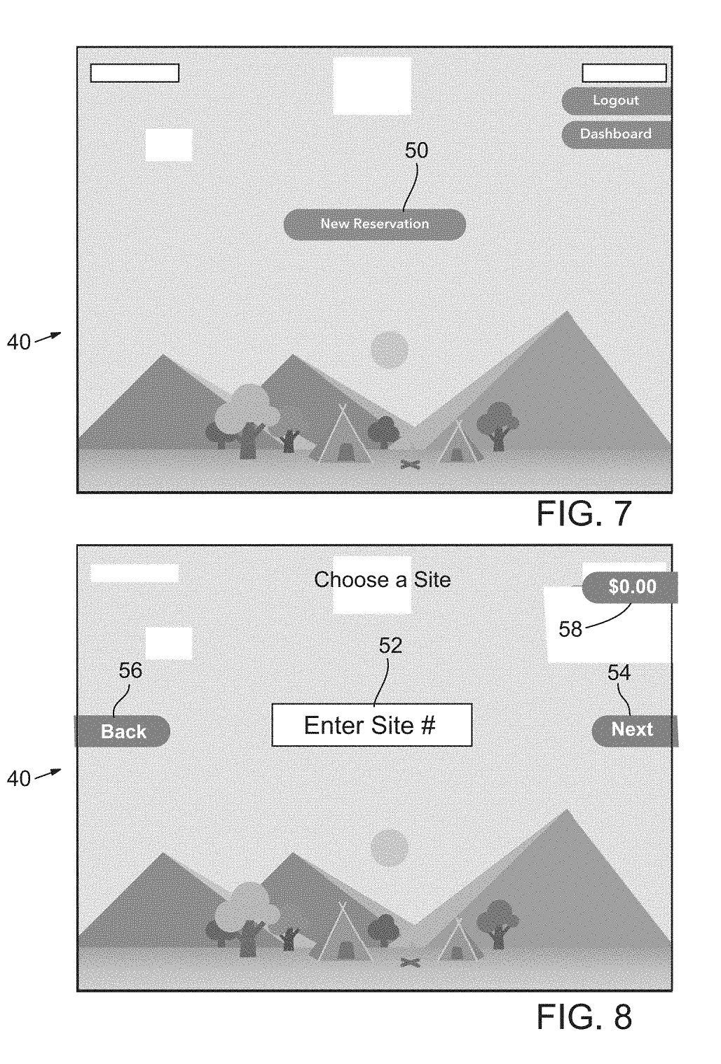

Fee collection apparatus 10 defines a menu-driven registration procedure pursuant to which users are prompted to input information and at the end of the procedure, provide payment with a credit or debit card. Once the user has completed inputting all required information and a payment card has been used to pay the associated fees, a receipt may be printed for the user to post at the campsite. The information that is requested by fee collection apparatus 10 for completing the registration process can vary widely depending on many factors such as the requirements for the particular location, and FIGS. 7 through 11 are provided to illustrate some possible embodiments of the registration process and information that may be sought.

Fee collection apparatus preferably includes at least the following fields for data input by users via input device 20:
Campsite number;
Visitor name;
Names of additional visitors at the campsite;
Check-in date;
Check-out date;
Vehicle license plate number and other information (such as state);
Number of additional vehicles at campsite;
   How long additional vehicle will be at campsite;
   License plate numbers for additional vehicles;
Number of days for current visit to campground;
   Display of the date range for current stay;
Does user have any applicable passes (e.g., Golden Age Pass);
Does user have any applicable coupons;
Variable values depending on time of year, additional services requested by the visitor (such as firewood, fuel, septic, ice, etc.) and applicable fees for selected additional services), etc.

The foregoing list is exemplary and not exclusive. It will be appreciated that the data input fields, values and factors vary depending on numerous situations at each campground such as the time of year, the type of campgrounds, what types of passes are typically used, possible discounts, etc. The user input is a menu-driven process that directs the user to answer specific questions relating to the installation at that particular location in order to be assessed the proper amount of fees.

The series of schematic illustrations of FIGS. 7 through 10 provide examples of the information that may be displayed on the display 40 when a user first begins using fee apparatus 10. The display may be adapted with a variety of information for the particular location where the fee apparatus 10 is being used. As an example, the screen may include the location (e.g., Yellowstone National Park, Madison Campground), the date, time, etc.

In FIG. 7 the display 40 is in a home state, ready for user input. The display is preferably a touch screen so the user begins by touching “New Reservation” 50. The menu-driven reservation process then begins and the next sequential screen display (FIG. 8) prompts the user to enter the campsite number 52. Most screens include prompts for either advancing to the next following screen at “Next” 54, or going back to the previous screen at “Back” 56. A display of applicable fees at a fee field 58 is also preferably displayed.

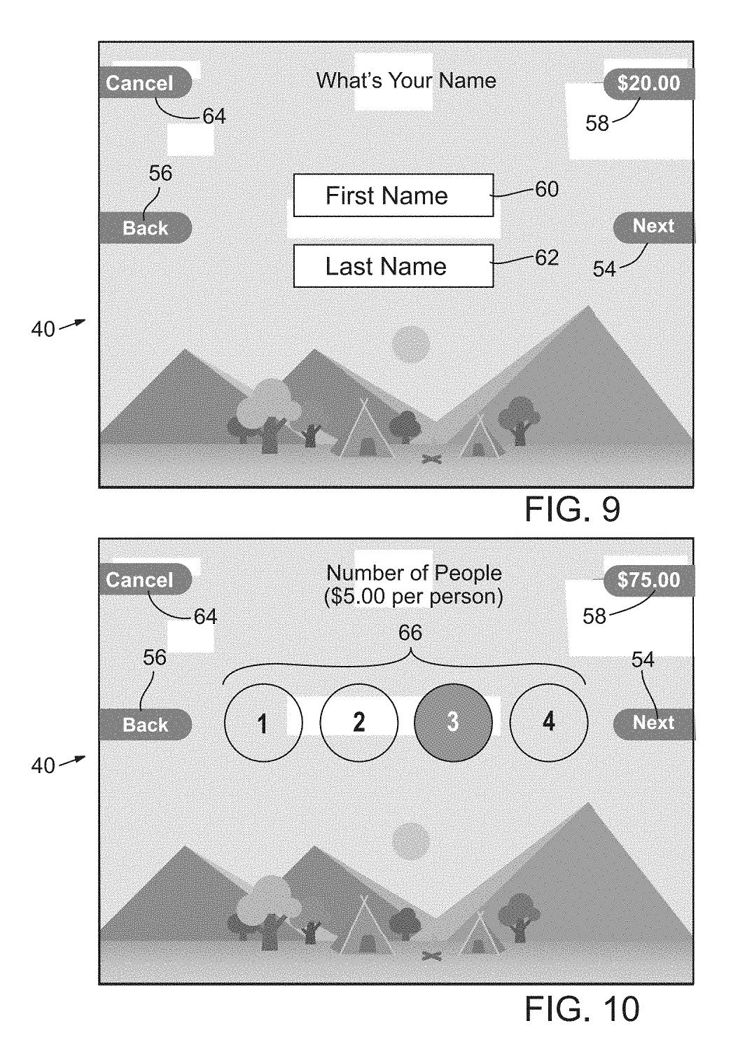

With the campsite number entered at 52 the next screen (FIG. 9) prompts the user to enter user identifying information such as first name 60, last name 6; fee information for the selected campsite is displayed at 58. The user is also given the option of canceling the transaction at cancel 64. FIG. 10 shows the next sequential screen and is a prompt for the user to enter the number of people 66 who will be staying at the campsite. With the number of people entered the fee information displayed at 58 is updated.

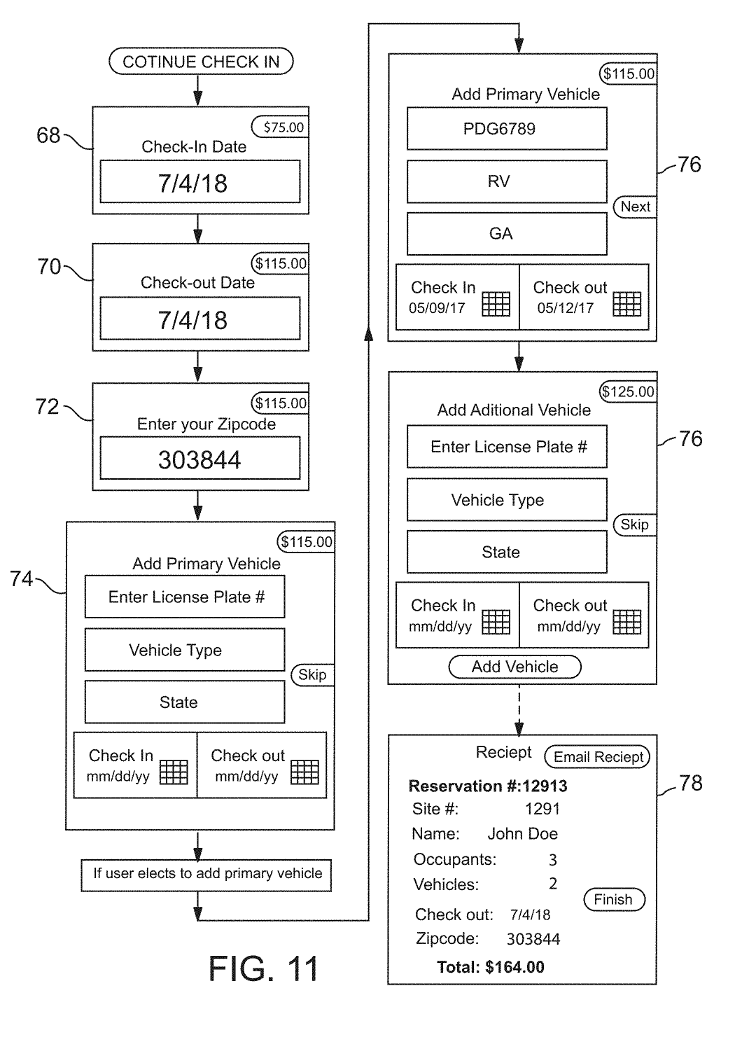

As noted above, the information required for the reservation procedure will vary with each installation. FIG. 11 continues with a series of next sequential screens that seek additional information from the user (with the graphics of FIGS. 7 through 10 omitted for simplification). Thus, the reservation process may include the following:
Check-in date 68;
Check-out date 70;
User ZIP code 72;
Vehicle identifying information 74, such as license plate number, vehicle type, state, etc.
Additional vehicles 76 at the site (if applicable—if the user does not include an additional vehicle the additional vehicle 76 screens are not displayed), etc.

The fee information field 58 is updated as appropriate to add fees associate with the information that the user inputs during the registration procedure. At the end of the registration process when the user has entered all information that is required, a payment amount due is generated and the amount due screen 78 is displayed and the user is prompted to insert a payment card (e.g., credit card, debit card, etc.) into card reader 44. As noted above, once the information has been entered by the user and the payment card has been read, a receipt may be printed for the user to place at, for instance, the campground.

Data entered by the user including payment card data are stored in computer 36 until such time as the data are transferred to a remote device, as detailed below. Thus, the invention contemplates a temporal delay between the time that user data are entered and stored in computer 36 and when the user data are transmitted from the computer 36 to a remote device. As detailed below, there is a second temporal delay between the time when the data are transmitted to and stored on the remote device from the kiosk and when the data are transmitted from the remote device to further processing at, for instance, a credit card processor.

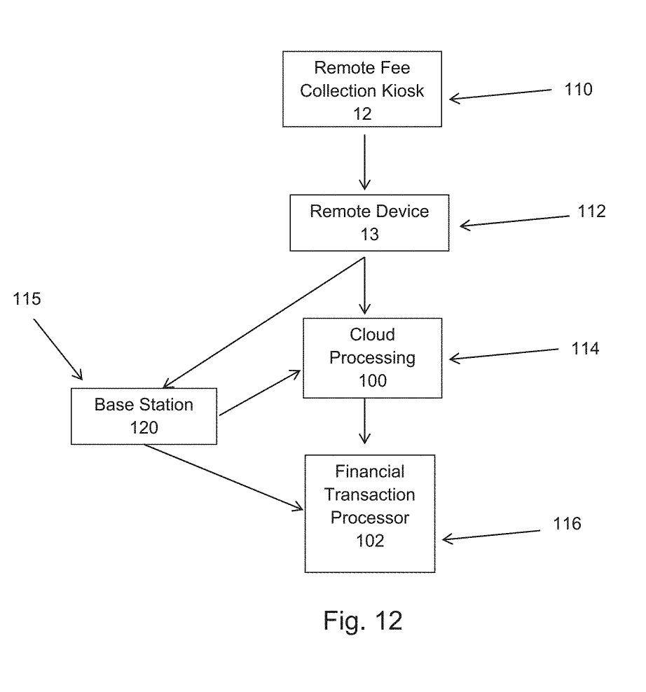

The invention contemplates alternate modes of transferring data that a customer inputs into the fee collection apparatus 10 to the campground office and to the financial transaction processor 102 (FIG. 12), for instance, a credit card processor. As noted, the fee collection apparatus is located in a remote area where there are no telecommunication services links such as Wi-Fi and cellular signals. As such, there is contemplated to be a temporal delay between the time when the customer inputs data into apparatus 10 and the user's payment card details are read by the card reader 44, and the time when the data are transferred to both the campground office and to the credit card processor. The apparatus 10 is fully compliant with applicable Payment Card Industry Data Security Standards (PCI DSS).

In a first and preferred embodiment for transferring data from apparatus 10 to the campground office and the financial transaction processor 102, the apparatus 10 is provided with wireless communications features such as a Bluetooth enabled functionality through a conventional antenna 52 or other wireless data transmission protocols including RFID. Data entered by a customer into apparatus 10, including credit card data, are stored in the apparatus 10. At the time when a campground employee is ready to download the data from apparatus 10, the employee approaches the apparatus within range of the wireless antenna 52 or other wireless protocol. The employee logs onto the apparatus 10 (with a portable table computer, cellular phone, or workstation if within range of the wireless antenna (collectively, “remote” devices 13); all equipped with appropriate encryption, pass codes and the like) and begins the data transmission from the apparatus 10 to the remote device. All data are transmitted in compliance with PCI DSS and all data are encrypted for security at all times during storage and transmission in accordance with PCI DSS standards and data from apparatus 10 are synchronized in the remote device 13. According to the PCI Compliance Guide at www.pcicomplianceguide.org PCI DSS standards is a set of security standards designed to ensure that companies that accept, process, store or transmit credit card information maintain a secure environment. The Payment Card Industry Security Standards Council (PCI SSC) was launched on Sep. 7, 2006 to manage the ongoing evolution of the Payment Card Industry (PCI) security standards with a focus on improving payment account security throughout the transaction process. The PCI DSS is administered and managed by the PCI SSC (www.pcisecuritystandards.org), an independent body that was created by the major payment card brands. Relevant documents may be found online at www.pcisecuritystandards.org.

If the campground employee downloads the data onto a portable device such as a tablet computer, the employee later transmits the data to a processing system 100 (via Wi-Fi or cellular connections or hard wired internet connections, as detailed below) or alternately to a base computer workstation 120 by usual communications links—WiFi, or hard connections, or by email and the like. Thus, there is contemplated a second temporal delay between the time when the data are transmitted from the kiosk to the remote device, and the time when the data are transmitted from the remote device to the processing system 100. Moreover, when the data are transmitted from the remote device 13 to processing system 100 the remote device is located remotely from the kiosk. In other words, the invention contemplates a temporal delay in the time of transfer of data from remote device 13 to processing system 100, and physical separation between the remote device and the kiosk when the transfer is made (for instance, the employee has physically moved the remote device from proximity to the kiosk where no telecommunications services are available to a location where Wi-Fi or cellular connections or hard wired connections are available). Processing system 100 is preferably a cloud based processing system. From the cloud based processing system 100 (or from base workstation 120) the credit card transaction data may be uploaded to the financial transaction processor 102.

In an alternate embodiment for transferring data from apparatus 10 to the campground office and the financial transaction processor is embodied in a data transfer device 80 (i.e., a remote device 13) according to the invention is shown in FIG. 5. In the preferred embodiment data transfer device 80 is a wand having capability of wirelessly receiving data from fee collection apparatus 10, the computer 36 in which is capable of transmitting encrypted data to the data wand 80. Wand 80 is, for purposes herein, a remote device 13. Transmission of data from computer 36 to wand 80 is according to known wireless data transfer protocols and/or with a physical connection (e.g. by plugging data transfer device 80 into a USB port on the fee collection apparatus 10 associated with computer 36) and as above, all data are transmitted in compliance with PCI DSS. As noted above, there are temporal delays and physical separation between the remote device and the kiosk when the transfer of data to the processing system 100 is made.

The computer base station 120 is shown schematically in FIG. 6 and comprises a computer that is adapted for receipt of data from data wand 80. The base station 120 is typically located remotely from the fee collection apparatus 10, such as in the park or campground headquarters. The operator transmits data from wand 80 either wirelessly or via physical connection to the base station 120 and the software in the base station generates reports as directed by the operator, and facilitates financial transactions and accounting.

The cloud based processing system 100 is an online system that is adapted for receipt of data from the remote device 13, for synchronizing the data, and for providing the payment card data to the financial transaction processor and facilitating a variety of reports to users. The financial transaction processor verifies user payment card data and successful payment of the amount due according to conventional protocols.

The general flow of data through fee collection apparatus is shown in the flow chart of FIG. 12. As detailed above,
(a) the user initially inputs required user-data in kiosk 12 at step 110, as detailed above, including payment card information (“user-data” refers to information entered by the user in kiosk 12, including payment card information).
Next, the user-data is transferred to a remote device 13 at step 112—data transferred to remote device 13 is synchronized in the remote device.
The user-data is then transferred from the remote device 13 to the cloud based processing system 100 at step 114, or alternately to the base station 120 at step 115.
Finally, the payment card data, which is a subset of the user-data, are transferred from the cloud based processing system 100 (or base station 120) to the financial transaction processor 102 at step 116. In the event that user-data are transferred from the remote device 13 to a base station 120, those data may be transferred to the cloud based processing system 100 and/or the card payment data may be transferred to the financial transaction processor, as desired according to the user's particular needs.
If for any reason a payment from the user's payment card is rejected by the financial transaction processor, the operator is notified an personnel at the campground may make appropriate inquiries to the user.

To reiterate, all data transfer at all times is in compliance with PCI DSS.

Fee collection apparatus 10 is configured for providing automatically generated periodic reports, which may be generated at any interval as set by the operator. The reports may be printed at the kiosk where the fee collection apparatus 10 is located by an onsite camp host, or may be transmitted to a remote location for printing and distribution and other evaluation. The format of the report follows standard formatting protocols or may be customized according to need. If a financial transaction is declined by the financial transaction processor 102, for instance, at step 116 of FIG. 12, the campground host may then visit the campsite to reconfirm payment details or otherwise correct the decline transaction.

Campground hosts or other personnel will perform daily routine inspection of the fee collection apparatus 10, including, for example, to insure proper operation, etc. Campground management will perform periodic review as well, including collection of all deposits, review of reports and reporting to agencies that are to receive the information, accounting, etc.

While fee collection apparatus 10 is designed to be robust and sturdy so that it may be installed in remote locations, those of skill in the art will recognize that the apparatus may be used in any variety of situations.

While the present invention has been described in terms of preferred and illustrated embodiments, it will be appreciated by those of ordinary skill that the spirit and scope of the invention is not limited to those embodiments, but extend to the various modifications and equivalents as defined in the appended claims.

I claim:

1. A fee collection apparatus and system for use in collecting fees in locations without telecommunications services, comprising:
a kiosk adapted for installation in a location in which telecommunications services are not available, the kiosk comprising:
a computer;
an input device;
a fee card reader;
a power supply;
wherein the computer is adapted for storing user data including fee card data, encrypting the user data and for transmitting the encrypted user data to a remote device;
a remote device adapted for receiving encrypted user data from the computer and for storing the encrypted user data; and
a processing system adapted for receiving the encrypted user data from the remote device and for processing fee card data to verify fee collections from a financial transaction processor.

2. The apparatus and system according to claim 1 in which the user data are encrypted in compliance with Payment Card Industry Data Security Standards (PCI DSS).

3. The apparatus and system according to claim 2 in which the encrypted user data are transmitted from the kiosk to the remote device using a Bluetooth connection or a radio frequency connection.

4. The apparatus and system according to claim 3 in which the encrypted user data are transmitted from the remote device to the processing system using a telecommunications service.

5. The apparatus and system according to claim 4 in which the telecommunications service is a Wi-Fi or cellular connection.

6. The apparatus and system according to claim 5 in which the processing system is a cloud-based system and wherein fee card data are transmitted from the cloud-based system to the financial transaction processor.

7. The apparatus and system according to claim 1 wherein the kiosk includes a printer for printing a receipt.

8. The apparatus and system according to claim 7 in which the power supply comprises a solar panel.

9. The apparatus and system according to claim 1 in which:
a. user data are input into the kiosk and stored by the computer at a first time;
b. data are transmitted from the computer to the remote device at a second time that is temporally delayed relative to the first time and in which the remote device is in proximity to the kiosk; and
c. data are transmitted from the remote device to the processing system at a third time that is temporally delayed relative to the second time and at a location remote from the kiosk at which telecommunications services are available.

10. A method for collecting fees and user data in locations without telecommunications services, comprising the steps of:
a. prompting a user to input user data into a computer at a kiosk that is installed in a location in which telecommunications services are not available, wherein the user data includes fee payment card data;
b. generating an amount due based on the user data input by the user;
c. storing the user data in the computer at the kiosk;
d. transmitting the user data from the computer to a remote device;
e. transmitting the user data from the remote device to a processing system and verifying user payment from a financial transaction processor.

11. The method according to claim 10 in which user data are input at a first time, the user data are transmitted from the computer to the remote device at a second time that is after the first time, and the user data are transmitted from the remote device to the processing system at a third time that is after the second time and at a location where telecommunications services are available.

12. The method according to claim 11 wherein all user data are encrypted according to Payment Card Industry Data Security Standards (PCI DSS).

13. The method according to claim 11 in which the user data are transmitted from the computer at the kiosk to the remote device using a Bluetooth connection.

14. The method according to claim 13 in which the user data are transmitted from the remote device to the processing system using a Wi-Fi connection.

15. The method according to claim 14 in which the processing system comprises a cloud-based processing system and including the step of transmitting user payment card data from the cloud-based processing system to the financial transaction processor.

16. The method according to claim 11 in which the kiosk is installed in a location at which grid power is not available and including the step of providing power to the kiosk from a solar panel.

17. A method for collecting fees and user data in locations without telecommunications services, comprising the steps of
a. installing a kiosk in a first location at which telecommunications services are not present, the kiosk comprising a computer, an input device, a fee card reader and a power supply;
b. prompting a user to input user data into the computer with the input device;
c. based on the user-input data, generating a fee amount due;
d. prompting the user to input payment card data into the computer;
e. storing in the computer the user data, the fee amount due and the payment card data;
f. at a time that is temporally delayed from the time when the user data, the fee amount due and the payment card data are stored in step e, transmitting the user data, the fee amount due and the payment card data to a remote device;
g. at a time that is temporally delayed from the time when the user data, the fee amount due and the payment card data are stored in step f, and at a second location at which telecommunications services are available and that is remote from the kiosk, transmitting the user data, the fee amount due and the payment card data from the remote device to a processing system and transmitting the payment card data to a financial transaction processor.

18. The method according to claim 17 including the step of encrypting the user data, the fee amount due and the payment card data.

19. The method according to claim 18 including the step of encrypting the user data, the fee amount due and the payment card data according to Payment Card Industry Data Security Standards (PCI DSS).

20. The method according to claim 18 in which the financial transaction processor verifies payment card data and processes payment of the fee amount due, and if the payment of the fee amount due is rejected, notifying an operator that the payment has been rejected.
